(19) United States
(12) Patent Application Publication
(10) Pub. No.: US 2013/0259605 A1
(43) Pub. Date: Oct. 3, 2013

(54) WASHER DEVICE FOR FASTENER DRIVER

(71) Applicant: Shun Ping Yao, Taichung (TW)

(72) Inventor: Shun Ping Yao, Taichung (TW)

(21) Appl. No.: 13/433,596

(22) Filed: Mar. 29, 2012

(51) Int. Cl. F16B 43/00

(52) U.S. Cl. 411/532

(57) ABSTRACT

A washer device for a fastener driver includes a layer having a number of washer members coupled together and located side by side, and having a hinge line formed between every two adjacent washer members for temporarily securing or coupling the washer members together, and for allowing the washer members to be selectively received or engaged with the nails or staples or fasteners that are hammered or punched out of the nose portion of the driver body member by the ejector. The washer members each include an orifice for selectively receiving or engaging with the nails or staples or fasteners, and one or more projections for separating the two superposed layers from each other.

### BACKGROUND OF THE INVENTION

1. Field of the Invention

The present invention relates to a nail or fastener driver, and more particularly to a washer device for a nail or fastener driver including a number of washer members coupled or superposed or stacked together for allowing the washer members to be suitably and easily and quickly and readily fed or introduced or moved or engaged into the washer holding and carrying and feeding device of the fastener driver by the user.

2. Description of the Prior Art

Typical staplers or nail or fastener drivers or driving machines comprise a magazine attached or mounted or secured to a lower or bottom portion of a driving machine body for receiving or accommodating a number of nails or fasteners, and an ejector or hammering or driving mechanism attached or mounted or secured to a front portion of the driving machine body for hammering or driving the nails or fasteners into work pieces.

For preventing the nails or fasteners from being deeply hammered or driven or engaged into the work pieces, some of the typical staplers or nail or fastener drivers or driving machines have been developed to provide a washer holding and carrying and feeding device for receiving or accommodating a number of washers and for feeding or supplying the washers toward the nose section of the fastener driver and for allowing the washers to be engaged with the nails or fasteners that are hammered or driven by the ejector or driving mechanism.

For example, U.S. Pat. No. 6,471,107 to Liu et al., U.S. Pat. No. 6,481,610 to Liu et al., and U.S. Pat. No. 6,908,022 to Schmitz disclose several of the typical staplers or nail or fastener drivers or driving machines each also comprising a washer holding and carrying and feeding device for receiving or accommodating a number of washers and for feeding or supplying the washers toward the nose section of the fastener driver and for allowing the washers to be engaged with the nails or fasteners that are hammered or driven by the ejector or driving mechanism.

However, the washers have not been coupled or superposed or stacked together such that the washers may not be easily and quickly and readily fed or introduced or moved or engaged into the washer holding and carrying and feeding device of the fastener driver by the user.

The present invention has arisen to mitigate and/or obviate the afore-described disadvantages of the conventional washer holding and carrying and feeding devices for fastener drivers.

### SUMMARY OF THE INVENTION

The primary objective of the present invention is to provide a washer device for a nail or fastener driver including a number of washer members coupled or superposed or stacked together for allowing the washer members to be suitably and easily and quickly and readily fed or introduced or moved or engaged into the washer holding and carrying and feeding device of the fastener driver by the user.

In accordance with one aspect of the invention, there is provided a washer device for a fastener driver comprising a layer including a number of washer members coupled together and located side by side, and including a hinge line formed between every two adjacent washer members for temporarily securing the washer members together, and including an orifice formed in each of the washer members for selectively receiving or engaging with the nails or staples or fasteners that are hammered or punched or driven or moved out of the nose portion of the driver body member by the ejector, and the first washer members each including at least one projection extended therefrom for engaging with the washer members of the other layer and for suitably separating the two superposed layers from each other and for forming one or more point contacts between the two superposed layers.

The washer members each include a first notch formed in one side portion thereof, and a second notch formed in an opposite side portion thereof for temporarily securing or coupling the washer members together.

The washer members each include a recess formed therein and communicative with the orifice of the washer member for reducing a thickness of the washer member around the orifice of the washer member.

One or more further layers may further be provided and each include a number of second washer members coupled together and located side by side, and each include a hinge line formed between every two adjacent second washer members for temporarily securing the second washer members together, and each include an orifice formed in each of the second washer members.

The first washer members each include at least one cavity formed therein and preferably aligned with the projection. The second washer members are disposed below the first washer members, and the at least one projection of the first washer member is contacted with the second washer member.

The first washer members each include at least one cavity formed therein and aligned with the at least one projection. The second washer members each may also include at least one cavity formed therein.

The first washer members each may further include a second projection extended therefrom. The first washer members each include a second cavity formed therein and aligned with the second projection.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a fastener driver having a washer holding and carrying and feeding device for receiving or accommodating a number of washer members of a washer device in accordance with the present invention;

FIG. 2 is a partial exploded view of the washer device for the fastener driver;

FIG. 3 is another partial exploded view illustrating a portion of the washer device for the fastener driver;

FIG. 4 is a further partial exploded view similar to FIG. 2, illustrating the other arrangement of the washer members of the washer device for the fastener driver;

FIG. 5 is a still further partial exploded view of the washer members of the washer device for the fastener driver as shown in FIG. 4; and

FIG. 6 is a still further partial exploded view similar to FIGS. 2 and 4, illustrating the further arrangement of the washer members of the washer device for the fastener driver.

### DETAILED DESCRIPTION OF THE PREFERRED EMBODIMENT

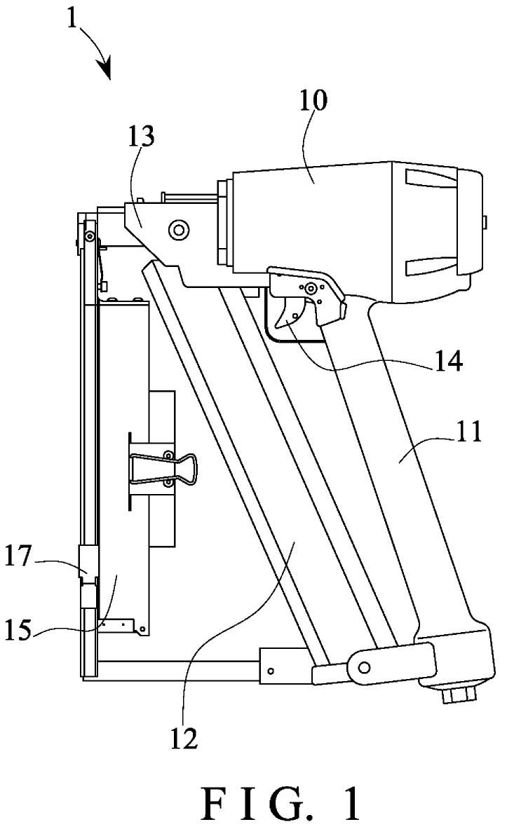

Referring to the drawings, and initially to FIG. 1, a nail or staple or fastener driver 1 in accordance with the present invention comprises a gun or driver member or body member 10 including a handle 11 for being grasped or held by the user, and including a cassette 12 attached or mounted or secured or coupled thereto, such as attached to the bottom or lower portion thereof for receiving or holding or carrying or accommodating the nails or staples or fasteners (not shown) and for feeding or supplying the nails or staples or fasteners toward the nose portion 13 of the driver member or body member 10, and including a trigger 14 attached or mounted or secured or coupled thereto, such as attached to the adjacent or abutting portion of the driver body member 10 and the handle 11 for being pulled or operated or actuated by the user.

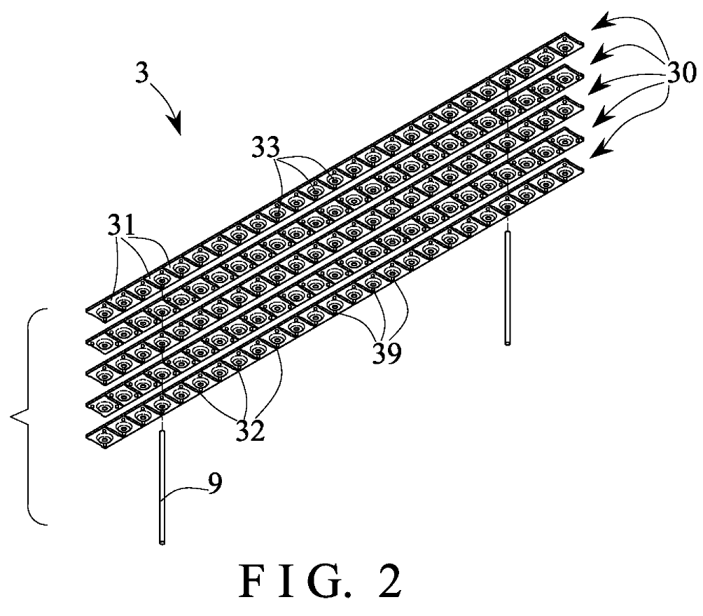

In operation, the trigger 14 may be pulled or operated or actuated by the user to actuate or operate or force a driver bit or shaft (not shown) to hammer or strike or push or force the nails or staples or fasteners out through the nose portion 13 of the driver body member 10. The staple or fastener driver 1 further comprises a washer holding and carrying and feeding device 15 attached or mounted or secured or coupled to the driver body member 10 and/or the cassette 12 for receiving or holding or carrying or accommodating the washer members 31 of a washer device 3 in accordance with the present invention (FIGS. 2-6) and for feeding or supplying the washer members 31 of the washer device 3 toward the nose portion 13 of the driver body member 10 and to be engaged with the nails or staples or fasteners (not shown).

The above-described structure or configuration for the driver body member 10 and the cassette 12 is typical and is not related to the present invention, and the washer holding and carrying and feeding device 15 is also not related to the present invention and will not be described in further details. As shown in FIG. 2, for example, the washer device 3 in accordance with the present invention may include one or more lines or rows or strips or layers 30, such as a first layer 30 and at least one second layer 30 each having a number of washer members 31 attached or mounted or secured or coupled together with cutting or hinge lines 32, for allowing the washer members 31 to be temporarily and disengageably or separably secured or coupled together and located side by side, and the layers 30 of the washer members 31 may be superposed or stacked together before being fed or introduced or moved or engaged into the washer holding and carrying and feeding device 15 of the fastener driver 1.

The washer members 31 of the layers 30 of the washer device 3 each include an orifice 33 formed therein, such as formed in the center portion thereof for selectively receiving or engaging with the nails or staples or fasteners that are hammered or punched or driven or moved out of the nose portion 13 of the driver body member 10 by the ejector (not shown). As also shown in FIG. 2, the orifices 33 of the washer members 31 are aligned with each other for selectively receiving or engaging with the rods or poles 9; i.e., one or more (such as two) rods or poles 9 may be engaged through the orifices 33 of the washer members 31 for arranging and moving or engaging the washer members 31 into the washer holding and carrying and feeding device 15 of the fastener driver 1 (FIG. 1), and may then be removed or disengaged from the washer members 31 and the washer holding and carrying and feeding device 15 of the fastener driver 1.

Accordingly, the rods or poles 9 may be provided for engaging through the orifices 33 of the washer members 31 and for organizing the washer members 31 of the layers 30 of the washer device 3 and for easily and quickly moving or engaging the washer members 31 into the washer holding and carrying and feeding device 15 of the fastener driver 1. However, the engagement of the rods or poles 9 with the orifices 33 of the washer members 31 of the layers 30 of the washer device 3 and for organizing the washer members 31 of the layers 30 of the washer device 3 has been filed in a co-pending patent application, and will not be described in further details.

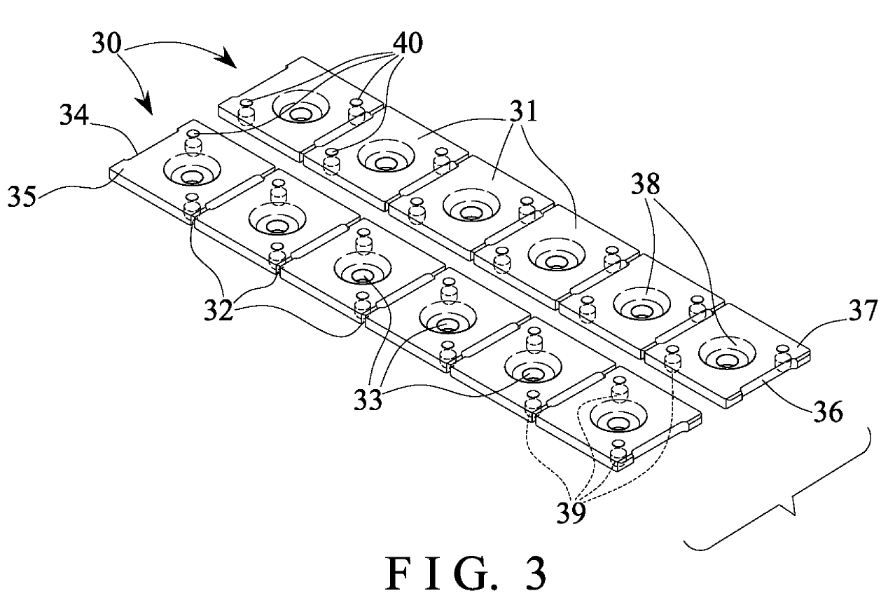

As shown in FIG. 3, each layer 30 of the washer device 3 includes a cutting or hinge line 32 formed or provided between every two adjacent washer members 31 for temporarily and disengageably or separably securing or coupling the washer members 31 together, and for allowing the washer members 31 to be separated from each other when the frontmost washer member 31 that is aligned with the nose portion 13 and/or the ejector (not shown) of the driver body member 10 is engaged with the nail or staple or fastener that is hammered or punched or driven or moved out of the nose portion 13 of the driver body member 10 by the ejector (not shown). It is preferable that the orifices 33 and the cutting or hinge lines 32 may be punched or cut or formed or shaped in an elongated member for forming the washer members 31 in the elongated member or in the layer 30.

It is preferable that the washer members 31 of the layers 30 of the washer device 3 each include a first depression or notch 34 formed in one side portion 35 thereof, and another or second depression or notch 36 formed in other or opposite side portion 37 thereof for reducing the cutting or hinge lines 32 and for allowing the washer members 31 to be separated from each other much easier. The washer member 31 may further include an enlarged compartment or recess 38 formed therein, such as formed in the upper or bottom portion thereof and communicative with the orifice 33 of the washer member 31 for suitably reducing the thickness of the washer member 31 around the orifice 33 of the washer member 31 and for allowing the nail or staple or fastener to be suitably engaged with the orifice 33 of the washer member 31 even when the nail or staple or fastener includes an outer diameter much greater than the inner diameter of the orifice 33 of the washer member 31.

It is preferable, but not necessarily that the washer member 31 may include a square or rectangular shape or outer contour. The washer members 31 of the layers 30 of the washer device 3 each may further include one or more (such as two) protrusions or projections 39 extended downwardly therefrom for engaging with the washer members 31 of the other layer 30 that are disposed below them, and for suitably separating the two superposed layers 30 from each other and for forming one or more (such as two) point contacts between the two superposed layers 30; and each may further include one or more (such as two) cavities 40 formed therein, such as formed in the upper portion thereof and aligned with the corresponding projections 39. It is preferable that the projections 39 of the washer members 31 include an outer diameter slightly greater than the inner diameter of the cavities 40 of the washer member 31 for preventing the projections 39 from being completely engaged into the corresponding cavities 40 of the washer member 31 and for suitably separating the two superposed layers 30 from each other for a selected spacing distance.

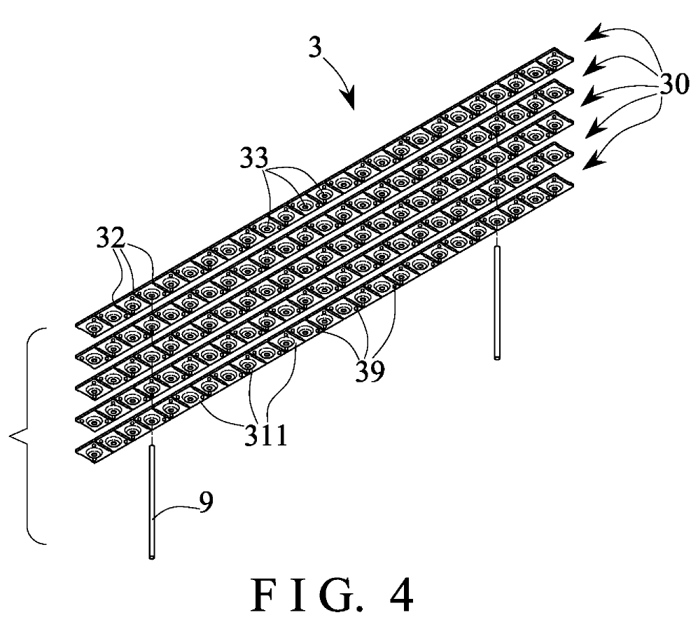

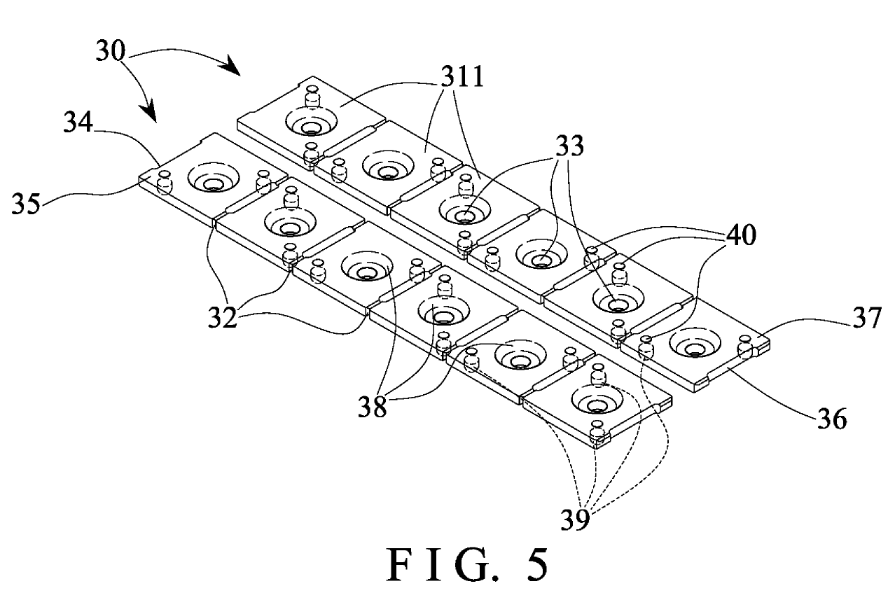

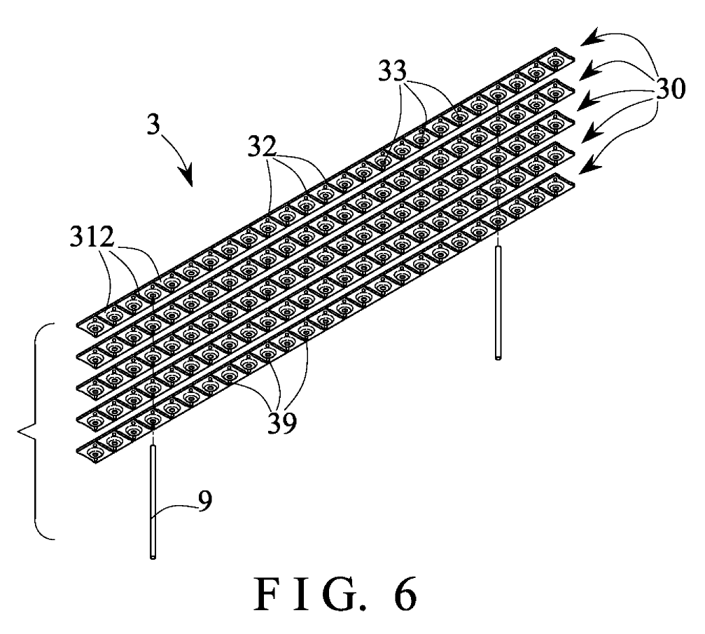

As shown in FIG. 3, the projections 39 of the washer members 31 of each layer 30 of the washer device 3 are arranged in the same direction or location, and the projections 39 of the washer members 31 of the other layer 30 are preferably arranged in the other direction or location different or offset from that of the other layer 30 for preventing the projections 39 from being engaged into the corresponding cavities 40 of the washer members 31 that are disposed below them. Alternatively, as shown in FIGS. 4-5, the projections 39 of the washer members 311 of each layer 30 of the washer device 3 may also be arranged in different direction or location; or as shown in FIG. 6, the projections 39 of the washer members 312 of the layers 30 of the washer device 3 may all be arranged in the same direction or location.

In operation, one of the layers 30 of the washer device 3, particularly the layer 30 that is located farther away from the driver body member 10 and the cassette 12 and the handle 11 will be moved or pushed forwardly toward the nose portion 13 of the driver body member 10 by the pusher device 17 (FIG. 1), and the frontmost washer member 31, 311, 312 will be aligned with the nose portion 13 and/or the ejector (not shown) of the driver body member 10 which may push or hammer or punch or drive or move the nail or staple or fastener out of the nose portion 13 of the driver body member 10 to engage with the frontmost washer member 31.

Accordingly, the washer device for the nail or fastener driver in accordance with the present invention includes a number of washer members coupled or superposed or stacked together for allowing the washer members to be suitably and easily and quickly and readily fed or introduced or moved or engaged into the washer holding and carrying and feeding device of the fastener driver by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A washer device for a fastener driver comprising:
a layer including a plurality of first washer members coupled together and located side by side, and including a hinge line formed between every two adjacent first washer members for temporarily securing said first washer members together, and including an orifice formed in each of said first washer members, and said first washer members each including at least one projection extended therefrom.

2. The washer device as claimed in claim 1, wherein said first washer members each include a first notch formed in one side portion thereof, and a second notch formed in an opposite side portion thereof.

3. The washer device as claimed in claim 1, wherein said first washer members each include a recess formed therein and communicative with said orifice of said first washer member for reducing a thickness of said first washer member around said orifice of said first washer member.

4. The washer device as claimed in claim 1, wherein said first washer members each include at least one cavity formed therein.

5. The washer device as claimed in claim 1 further comprising at least one second layer including a plurality of second washer members coupled together and located side by side, and including a hinge line formed between every two adjacent second washer members for temporarily securing said second washer members together, and including an orifice formed in each of said second washer members.

6. The washer device as claimed in claim 5, wherein said second washer members are disposed below said first washer members, and said at least one projection of said first washer member is contacted with said second washer member.

7. The washer device as claimed in claim 6, wherein said first washer members each include at least one cavity formed therein and aligned with said at least one projection.

8. The washer device as claimed in claim 6, wherein said second washer members each include at least one cavity formed therein.

9. The washer device as claimed in claim 1, wherein said first washer members each further include a second projection extended therefrom.

10. The washer device as claimed in claim 9, wherein said first washer members each include a second cavity formed therein and aligned with said second projection.
